(19) United States
(12) Patent Application Publication
(10) Pub. No.: US 2017/0183470 A1
(43) Pub. Date: Jun. 29, 2017

(54) AMINO-CONTAINING SILICA PARTICLE, COMPOSITION FOR FORMING POLYIMIDE AEROGEL, POLYIMIDE AEROGEL AND METHOD OF FABRICATING THE SAME, POLYIMIDE AEROGEL-CONTAINING COMPOSITE MATERIAL

(71) Applicant: Taiwan Textile Research Institute, New Taipei City (TW)

(72) Inventors: Shang-Chih Chou, New Taipei City (TW); Meng-Tzu Hsiao, New Taipei City (TW)

(21) Appl. No.: 15/051,685

(22) Filed: Feb. 24, 2016

(30) Foreign Application Priority Data
Dec. 25, 2015 (TW) 104143692

(51) Int. Cl. C08J 9/00; C01B 33/12; C08J 9/28; C08J 9/16

(52) U.S. Cl. CPC C08J 9/0042; C08J 9/16; C01B 33/12; C08J 9/286; C08J 2205/026; C08J 2207/06; C08J 2379/08

(57) ABSTRACT

An amino-containing silica particle is provided. The amino-containing silica particle is obtained by hydrolysis-condensation reaction of an alkoxy silane represented by formula (I), an alkoxy silane represented by formula (II) and a catalyst:

Si(OR¹)₄ formula (I)

(NH₂—Y)ₘ—Si(OR²)₄₋ₘ formula (II)

wherein in formula (I), R¹ is a C₁-C₁₀ alkyl group, and in formula (II), Y is a C₁-C₁₀ alkyl group or a C₂-C₁₀ alkenyl group, R² is a C₁-C₁₀ alkyl group, and m is an integer of 1 to 3.

### CROSS-REFERENCE TO RELATED APPLICATION

This application claims the priority benefit of Taiwan application serial no. 104143692, filed on Dec. 25, 2015. The entirety of the above-mentioned patent application is hereby incorporated by reference herein and made a part of this specification.

### BACKGROUND OF THE INVENTION

Field of the Invention

The invention relates to a silica particle and a polyimide aerogel prepared using the silica particle, and particularly relates to an amino-containing silica particle and a polyimide aerogel prepared using the silica particle.

Description of Related Art

An aerogel is a unique solid having high porosity. The aerogel with high porosity has characteristics such as high surface area, low refractive index, low dielectric constant, low thermal conductivity, and acoustic insulation. Therefore, the aerogel has broad application prospects in fields such as integrated circuits, energy saving, and aeronautics.

In a conventional method of fabricating the aerogel, in order to avoid collapse of porous structures in a drying process, it is usually required to use low surface energy solvent, such as n-hexane or pentane, to perform solvent exchange or to use carbon dioxide supercritical fluid to perform solvent exchange and/or drying. However, the low surface energy solvent has high harmfulness due to high neurotoxicity. Besides, a high pressure process is required to perform solvent exchange and/or drying by the carbon dioxide supercritical fluid, thereby not only consuming energy but also increasing manufacturing cost resulted from investing devices such as special equipment for withstand supercriticality. Additionally, it also requires a lot of manpower and time.

### SUMMARY OF THE INVENTION

For this reason, the invention provides an amino-containing silica particle, a composition for forming a polyimide aerogel, a polyimide aerogel and a method of fabricating the same. The polyimide aerogel has characteristics such as high porosity, good thermal insulation, good flexibility, flame retardancy, UV resistance, chemical resistance, and low dielectric constant. Also, low surface energy solvent such as n-hexane or pentane, and the carbon dioxide supercritical fluid are not required to use in the process. Furthermore, the polyimide aerogel is suitable to apply to a composite material.

The invention provides an amino-containing silica particle obtained by hydrolysis-condensation reaction of an alkoxy silane represented by formula (I), an alkoxy silane represented by formula (II) and a catalyst:

Si(OR¹)₄ formula (I)

(NH₂—Y)ₘ—Si(OR²)₄₋ₘ formula (II)

wherein in formula (I), R¹ is a C₁-C₁₀ alkyl group, and in formula (II), Y is a C₁-C₁₀ alkyl group or a C₂-C₁₀ alkenyl group, R² is a C₁-C₁₀ alkyl group, and m is an integer of 1 to 3.

According to an embodiment of the invention, an equivalent number of amino group of the amino-containing silica particle is 5 mmole/g to 10 mmole/g.

According to an embodiment of the invention, the alkoxy silane represented by formula (I) includes tetraethoxysilane, and the alkoxy silane represented by formula (II) includes 3-aminopropyltriethoxysilane.

The invention provides a composition for forming a polyimide aerogel including a diamine monomer, a tetracarboxylic dianhydride monomer, the above-mentioned amino-containing silica particle, and a solvent. The molar ratio of the diamine monomer to the tetracarboxylic dianhydride monomer is 1:1 to 1:1.5. The weight percent of the amino-containing silica particle is 10 wt % to 40 wt %, based on the total weight of the composition for forming the polyimide aerogel.

According to an embodiment of the invention, the solid content of the composition for forming the polyimide aerogel is 5 wt % to 20 wt %.

According to an embodiment of the invention, the diamine monomer is 4,4′-oxydianiline (ODA), 3,3′-dimethylbenzidine (DMB), p-phenylenediamine (p-PDA), m-phenylenediamine (m-PDA), 2,2′-bis[4-(4-aminophenoxyphenyl)] propane (BAPP), or 2,2-bis(trifluoromethyl) benzidine (TFMB), and the tetracarboxylic dianhydride monomer is 3,3′,4,4′-biphenyltetracarboxylic dianhydride (BPDA), pyromellitic dianhydride (PMDA), 3,3′,4,4′-benzophenone tetracarboxylic dianhydride (BTDA), 4,4′-oxydiphthalic anhydride (ODPA), or 4,4′-(hexafluoroisopropylidene)diphthalic anhydride (6FDA).

According to an embodiment of the invention, the solvent is selected from at least one of N-methylpyrrolidone, dimethylacetamide, dimethylformamide, tetrahydrofuran, and phenol.

The invention provides a method of fabricating a polyimide aerogel including the following steps. A diamine monomer, a tetracarboxylic dianhydride monomer, and an amino-containing silica particle are uniformly mixed in a solvent to obtain the above-mentioned composition for forming the polyimide aerogel. A polycondensation and cyclization reaction of the composition for forming the polyimide aerogel is performed to form a wet gel. A solvent exchange treatment is performed on the wet gel with a mixture solution of acetone and water. A drying treatment is performed on the wet gel which has been subjected to the solvent exchange treatment.

According to an embodiment of the invention, the volume ratio of acetone to water in the mixture solution of acetone and water is 10:90 to 90:10.

According to an embodiment of the invention, the method of fabricating the polyimide aerogel further comprises adding a crosslinking agent into the wet gel before performing the solvent exchange treatment, wherein the additive amount of the crosslinking agent is 1 wt % to 10 wt %, based on the total weight of the wet gel.

According to an embodiment of the invention, the crosslinking agent is a diisocyanate-based crosslinking agent, a diamine crosslinking agent, a triamine crosslinking agent, or a glycol-based crosslinking agent.

According to an embodiment of the invention, the method of fabricating the polyimide aerogel further comprises adding a surfactant into the mixture solution of acetone and water, wherein the additive amount of the surfactant is 0.01 wt % to 1 wt %, based on the total weight of the mixture solution of acetone and water.

According to an embodiment of the invention, the surfactant is a fluorine-based surfactant.

The invention provides a polyimide aerogel fabricated by the above-mentioned method of fabricating the polyimide aerogel.

According to an embodiment of the invention, the porosity of the polyimide aerogel is 85% to 95%.

According to an embodiment of the invention, the thickness of the polyimide aerogel is 0.1 mm to 1 mm.

The invention provides a polyimide aerogel-containing composite material including a fabric and the above-mentioned polyimide aerogel, wherein the fabric and the polyimide aerogel are composited with each other.

Based on the above description, in the invention, the polyimide aerogel is fabricated by using the composition including the diamine monomer and the tetracarboxylic dianhydride monomer in a specific ratio range, and a specific content range of the amino-containing silica particle fabricated by using the alkoxy silane represented by formula (I) and the alkoxy silane represented by formula (II). Thereby, the low surface energy solvent such as n-hexane or pentane, and the carbon dioxide supercritical fluid are not required to use in the process of the polyimide aerogel, and the polyimide aerogel has characteristics such as high porosity, good thermal insulation, good flexibility, flame retardancy, UV resistance, chemical resistance, and low dielectric constant.

In order to make the aforementioned features and advantages of the disclosure more comprehensible, embodiments are described in detail below.

### DESCRIPTION OF THE EMBODIMENTS

In the specification, scopes represented by “a numerical value to another numerical value” are schematic representations in order to avoid listing all of the numerical values in the scopes in the specification. Therefore, the recitation of a specific numerical range covers any numerical value in the numerical range and a smaller numerical range defined by any numerical value in the numerical range, as is the case with any numerical value and a smaller numerical range thereof in the specification.

In order to prepare a polyimide aerogel having a good physical property, without using low surface energy solvent such as n-hexane or pentane, and the carbon dioxide supercritical fluid in a process, and being suitable to apply to a composite material, the invention provides an amino-containing silica particle, and a composition for forming a polyimide aerogel including the amino-containing silica particle. The polyimide aerogel fabricated by the composition for forming the polyimide aerogel can achieve the above advantages. In the following, embodiments are described to illustrate the amino-containing silica particle, the composition for forming the polyimide aerogel, the polyimide aerogel and the method of fabricating the same, and a polyimide aerogel-containing composite material of the invention in detail as examples according to which the present invention can be surely implemented.

[Amino-Containing Silica Particle]

An amino-containing silica particle of an embodiment of the invention is obtained by hydrolysis-condensation reaction of an alkoxy silane represented by formula (I), an alkoxy silane represented by formula (II) and a catalyst:

Si(OR¹)₄ formula (I)

(NH₂—Y)ₘ—Si(OR²)₄₋ₘ formula (II)

In formula (I), R¹ is a C₁-C₁₀ alkyl group. In particular, examples of the alkoxy silane represented by formula (I) are, but not limited to, tetramethoxysilane, tetraethoxysilane, tetrapropoxysilane, and tetrabutoxysilane, for example. A preferred example of the alkoxy silane represented by formula (I) is tetraethoxysilane.

In formula (II), Y is a C₁-C₁₀ alkyl group or a C₂-C₁₀ alkenyl group, R² is a C₁-C₁₀ alkyl group, and m is an integer of 1 to 3. In particular, examples of the alkoxy silane represented by formula (II) are, but not limited to, 3-aminopropyltrimethoxysilane, 3-aminopropyltriethoxysilane, 3-aminoethylaminopropyltrimethoxysilane, and 3-aminoethylaminopropyltriethoxysilane, for example. A preferred example of the alkoxy silane represented by formula (II) is 3-aminopropyltriethoxysilane.

The catalyst is an acid catalyst or a basic catalyst, for example. In particular, examples of the acid catalyst include, but not limited to, inorganic acids such as hydrochloric acid, nitric acid, sulfuric acid, sulfurous acid, phosphoric acid, chloric acid, chlorous acid, hypochlorous acid; and organic carboxylic acids such as acetic acid, formic acid, propionic acid, oxalic acid, malonic acid, succinic acid, citric acid, malic acid, adipic acid, azelaic acid. Examples of the basic catalyst include, but not limited to, alkali metal hydroxides such as lithium hydroxide, sodium hydroxide, potassium hydroxide; ammonium compounds such as ammonium hydroxide, ammonium chloride, ammonium bromide; basic sodium phosphate salts such as sodium metaphosphate, sodium pyrophosphate, sodium polyphosphate; aliphatic amines such as allylamine, diallylamine, triallylamine, isopropylamine, diisopropylamine, ethylamine, diethylamine, triethylamine, 2-ethylhexylamine, 3-ethoxypropylamine, diisobutylamine, 3-(diethylamino)propylamine, bis-2-ethylhexylamine, 3-(dibutylamino)propylamine, tetramethylethylenediamine, tert-butylamine, sec-butyl amine, propyl amine, 3-(methylamino)propylamine, 3-(dimethylamino)propylamine, 3-methoxyamine, dimethylethanolamine, methyldiethanolamine, diethanolamine, triethanolamine; and nitrogen-containing hetracyclic compounds such as morpholine, N-methylmorpholine, 2-methylmorpholine, piperazine and derivatives thereof, piperidine and derivatives thereof, imidazole and derivatives thereof. Additionally, the usage amount of the catalyst may depend on a pH value of the hydrolysis-condensation reaction, wherein the acid catalyst is used to adjust pH from 2 to 4, for example, and the basic catalyst is used to adjust pH from 10 to 12, for example.

Additionally, the hydrolysis-condensation reaction is performed in a solvent, and can be performed by any method known to one of ordinary skill in the art. For example, a method of performing the hydrolysis-condensation reaction includes the following steps. First, the alkoxy silane represented by formula (I) and the alkoxy silane represented by formula (II) are dissolved in the solvent at the temperature of 25° C. to 35° C. Next, the catalyst is added with stirring, and the reaction is stirred for 3 hours to 5 hours at the temperature of 25° C. to 35° C. In addition, after the hydrolysis-condensation reaction is completed, a drying treatment can further be performed to remove the solvent. A method of the drying treatment includes, for example, using a heating plate or a hot air circulation oven for heating, wherein a temperature condition is, for example, 60° C. to 80° C., and a time condition is, for example, 3 hours to 5 hours.

The solvent is not particularly limited, as long as it can dissolve the alkoxy silane represented by formula (I), the alkoxy silane represented by formula (II), and the catalyst. Specifically, in the embodiment, examples of the solvent include, but not limited to, water; alcohol solvents such as methanol, ethanol, n-propanol, 2-propanol, n-butanol, 2-butanol, tert-butanol; dimethylacetamide-based solvents, and N-methylpyrrolidone-based solvents. Additionally, the solvents mentioned above may be used alone or as a mixture of two or more.

Additionally, depending on need, a pH regulator may be added to adjust the pH of the solution to facilitate the hydrolysis-condensation reaction. The pH regulator includes buffering agents such as boric acid, or phosphoric acid; acids such as hydrochloric acid, or sulfuric acid; or bases such as sodium hydroxide, or potassium hydroxide, for example.

Additionally, in the embodiment, the equivalent number of amino group of the amino-containing silica particle is 5 mmole/g to 10 mmole/g, preferably 6 mmole/g to 8 mmole/g. Specifically, if the equivalent number of amino group of the amino-containing silica particle is less than 5 mmole/g, the crosslinking reaction is incomplete. If the equivalent number of amino group of the amino-containing silica particle is more than 10 mmole/g, the excess amount results in reagent waste.

[Composition for Forming Polyimide Aerogel]

A composition for forming a polyimide aerogel of an embodiment of the invention includes a diamine monomer, a tetracarboxylic dianhydride monomer, the amino-containing silica particle of any of the above-mentioned embodiments, and a solvent. The molar ratio of the diamine monomer to the tetracarboxylic dianhydride monomer is 1:1 to 1:1.5, preferably 1:1 to 1:1.1. The weight percent of the amino-containing silica particle is 10 wt % to 40 wt %, preferably 20 wt % to 30 wt %, based on the total weight of the composition for forming the polyimide aerogel.

In particular, examples of the diamine monomer are, but not limited to, 4,4′-oxydianiline (ODA), 3,3′-dimethylbenzidine (DMB), p-phenylenediamine (p-PDA), m-phenylenediamine (m-PDA), 2,2′-bis[4-(4-aminophenoxyphenyl)] propane (BAPP), and 2,2-bis(trifluoromethyl) benzidine (TFMB), for example. Preferred examples of the diamine monomer are 4,4′-diaminodiphenyl ether, and 3,3′-dimethylbenzidine.

Examples of the tetracarboxylic dianhydride monomer are, but not limited to, 3,3′,4,4′-biphenyltetracarboxylic dianhydride (BPDA), pyromellitic dianhydride (PMDA), 3,3′,4,4′-benzophenone tetracarboxylic dianhydride (BTDA), 4,4′-oxydiphthalic anhydride (ODPA), and 4,4′-(hexafluoroisopropylidene)diphthalic anhydride (6FDA), for example. A preferred example of the tetracarboxylic dianhydride monomer is 3,3′,4,4′-biphenyltetracarboxylic dianhydride (BPDA).

The related descriptions of the amino-containing silica particle have been illustrated in the above-mentioned embodiments in detail, and thus will not be repeated here.

The solvent is not particularly limited, as long as it can dissolve the diamine monomer, the tetracarboxylic dianhydride monomer, and the amino-containing silica particle. In the embodiment, the solvent is selected from at least one of N-methylpyrrolidone, dimethylacetamide, dimethylformamide, tetrahydrofuran, and phenol, for example. Specifically, an example of phenol includes m-phenol.

Additionally, the solid content of the composition for forming the polyimide aerogel is 5 wt % to 20 wt %, preferably 8 wt % to 15 wt %. Specifically, if the solid content of the composition for forming the polyimide aerogel is less than 5 wt %, the viscosity of the composition for forming the polyimide aerogel is too low so that the composition for forming the polyimide aerogel cannot be processed. If the solid content of the composition for forming the polyimide aerogel is more than 20 wt %, the viscosity of the composition for forming the polyimide aerogel is too high to decrease the porosity of the formed polyimide aerogel.

[Polyimide Aerogel and Method of Fabricating the Same]

A method of fabricating a polyimide aerogel of an embodiment of the invention includes the following steps. First, the composition for forming the polyimide aerogel of any of the above-mentioned embodiments is prepared. Specifically, the method of fabricating the composition for forming the polyimide aerogel includes mixing the diamine monomer, the tetracarboxylic dianhydride monomer, and the amino-containing silica particle uniformly in the solvent at the temperature of 0° C. to 35° C. The method of mixing is not particularly limited, as long as it can mix the diamine monomer, the tetracarboxylic dianhydride monomer, and the amino-containing silica particle uniformly in the solvent to facilitate performing the subsequent polycondensation reaction. Additionally, the related descriptions of the diamine monomer, the tetracarboxylic dianhydride monomer, the amino-containing silica particle, and the solvent of the composition for forming the polyimide aerogel have been illustrated in the above-mentioned embodiments in detail, and thus will not be repeated here.

Then, a polycondensation and cyclization reaction of the composition for forming the polyimide aerogel is performed to form a wet gel. Specifically, in this step, the amino groups of the diamine monomer and the amino-containing silica particle are both reacted with the carboxylic anhydride groups of the tetracarboxylic dianhydride monomer to perform the polycondensation and cyclization reaction so as to from imide bonds. That is, in the embodiment, the wet gel includes a composite gel solid matter having imide bonds and having fluidity.

More specifically, in the embodiment, the method of forming the wet gel includes continuing stirring the composition for forming the polyimide aerogel and adding pyridine and acetic anhydride used as chemical catalyst at the temperature of 0° C. to 35° C. to perform the polycondensation and cyclization reaction for 3 hours to 8 hours, wherein the volume ratio of pyridine to acetic anhydride is about 2:1.

Then, a solvent exchange treatment is performed on the wet gel with a mixture solution of acetone and water. The solvent exchange treatment is a step that the solvent in the wet gel is exchanged to a solvent which is suitable to be removed in the subsequent drying treatment. Specifically, in the embodiment, the solvent which is suitable to be removed in the subsequent drying treatment is the mixture solution of acetone and water. That is, the solvent exchange treatment does not require the use of the carbon dioxide supercritical fluid or the low surface energy solvents, such as n-hexane, pentane, or with high toxicity. Thereby, the method of fabricating the polyimide aerogel of the invention has low manufacturing cost and time, and can avoid the environmental, biological, and other damages so as to increase applicability.

In the embodiment, in the mixture solution of acetone and water, the volume ratio of acetone to water is 10:90 to 90:10, preferably from 10:70 to 70:30. Specifically, if the volume ratio of acetone to water is less than 10:90 or more than 90:10, the polyimide aerogel formed subsequently would be uneven shrinkage.

Additionally, the solvent exchange treatment can be performed by any method known to one of ordinary skill in the art. For example, the wet gel is immersed in the mixture solution of acetone and water for 1 hour to 8 hours at the temperature of 0° C. to 35° C. so as to perform the solvent exchange treatment. The usage amount of the mixture solution of acetone and water is not particularly limited, as long as the solvent in the wet gel can be fully exchanged. In an embodiment, the usage amount of the mixture of acetone and water is 1 time to 3 times volume relative to the wet gel.

Then, a drying treatment is pedal lied on the wet gel which has been subjected to the solvent exchange treatment, thereby obtaining the polyimide aerogel. In the embodiment, the drying treatment is performed by using a direct drying method or a freeze drying method. That is, the drying treatment does not require the use of the carbon dioxide supercritical fluid, thereby the method of fabricating the polyimide aerogel of the invention has low manufacturing cost and time.

From a point of view of reducing the manufacturing cost, the direct drying method can be used. The direct drying method is a method dried by standing at room temperature and pressure, namely without any extra pressure or heating to perform drying. Additionally, the freeze drying method can be performed by any method known to one of ordinary skill in the art. For example, the freeze drying method is performed by the following steps: freezing the wet gel which has been subjected to the solvent exchange treatment at −10° C. to 0° C., then performing drying under vacuum (from 0.01 atm to 0.03 atm).

Additionally, in the embodiment, from a point of view of increasing structural strength of the polyimide aerogel to avoid hole collapse occurred in the drying treatment, the method of fabricating the polyimide aerogel further comprises adding a crosslinking agent into the wet gel before performing the solvent exchange treatment. Specifically, the additive amount of the crosslinking agent is 1 wt % to 10 wt %, preferably 1 wt % to 5 wt %, based on the total weight of the wet gel. Additionally, examples of the crosslinking agent are, but not limited to, a diisocyanate-based crosslinking agent, a diamine crosslinking agent, a triamine crosslinking agent, and a glycol-based crosslinking agent, for example. The diisocyanate-based crosslinking agent is diphenyl methane diisocyanate, toluene diisocyanate, isophorone diisocyanate, dicyclohexyl methane diisocyanate, or lysine diisocyanate, for example.

Additionally, in the embodiment, from a point of view of reducing interfacial surface energy to inhibit shrinkage occurred in the polyimide aerogel in the drying treatment, the method of fabricating the polyimide aerogel further comprises adding a surfactant into the mixture solution of acetone and water. Specifically, the additive amount of the surfactant is 0.01 wt % to 5 wt %, preferably 0.1 wt % to 3 wt %, based on the total weight of the mixture solution of acetone and water. Additionally, the surfactant is a fluorine-based surfactant, for example. Types of the fluorine-based surfactant are not particularly limited to the invention. Also, commercial products can be used, such as commercial fluorine-based surfactant that the model numbers thereof are Novec™ 4200, Novec™ 4300, FC-4430, FC-4434, FC-5120, S-111n, S-113, S-121, S-131, S-132, S-141, S-145, SA-100, S-381, and S-393, etc.

Another embodiment of the invention further provides a polyimide aerogel. The polyimide aerogel is fabricated by any of the method of fabricating the polyimide aerogel of the above-mentioned embodiments. Specifically, the porosity of the polyimide aerogel is about 85% to 95%, the thickness of the polyimide aerogel is about 0.1 mm to 1 mm, and the heat transfer coefficient of the polyimide aerogel is about 30 mW/m·k to 80 mW/m·k.

Additionally, when 1 kg of external force is applied to the polyimide aerogel for bending, the maximum bending angle of the polyimide aerogel is about 270 degrees to 360 degrees. That is, the polyimide aerogel of the invention has good flexibility.

It should be noted that, as mentioned above, the polyimide aerogel is fabricated by using the composition including the diamine monomer and the tetracarboxylic dianhydride monomer in a specific ratio range, and a specific content range of the amino-containing silica particle fabricated by using the alkoxy silane represented by formula (I) and the alkoxy silane represented by formula (II). Accordingly, the low surface energy solvents such as n-hexane, or pentane, and the carbon dioxide supercritical fluid are not required to use in the process. Also, the polyimide aerogel has characteristics such as high porosity, good thermal insulation, good flexibility, flame retardancy, UV resistance, chemical resistance, and low dielectric constant. Therefore, the polyimide aerogel of the invention has the advantages of having excellent productivity and physical property simultaneously that the present aerogel is difficult to achieve.

Furthermore, since the polyimide aerogel has the above-mentioned advantages, it can be applied to a variety of fields such as textile industry, a construction field, a traffic transport field, home appliances, a semiconductor field, and industrial equipment. Hereinafter, the examples of the polyimide aerogel applied to textile industry are illustrated.

[Polyimide Aerogel-Containing Composite Material]

A polyimide aerogel-containing composite material of an embodiment of the invention includes a fabric and the polyimide aerogel of any of the above-mentioned embodiments, wherein the fabric and the polyimide aerogel are composited with each other. Specifically, examples of the fabric are, but not limited to, woven fabric, knitted fabric, three dimensional fabric, and non-woven fabric, for example. The related descriptions of the polyimide aerogel have been illustrated in the above-mentioned embodiments in detail, and thus will not be repeated here. Additionally, the method of compositing the fabric and the polyimide aerogel with each other includes coating or immersing the wet gel which has been subjected to the solvent exchange treatment on the fabric, then performing a drying treatment, for example. The method of coating can be the normal coating methods such as a dipping coating method, a spin-on coating method, a spraying coating method, a brush coating method, a roller transfer method, a screen printing method, an ink jet method, or a flexographic printing method. The drying treatment may be the same as the drying treatment performed when the polyimide aerogel is fabricated, and the related descriptions of the drying treatment have been illustrated in the above-mentioned embodiments in detail, and thus will not be repeated here.

It should be noted that, as mentioned above, the polyimide aerogel has good thermal insulation, flame retardancy, UV resistance, and chemical resistance, thereby enhancing the thermal insulation, flame retardancy, UV resistance, and chemical resistance of the fabric. That is, the polyimide aerogel-containing composite material also has thermal insulation, flame retardancy, UV resistance, and chemical resistance. The polyimide aerogel has high porosity, thereby the polyimide aerogel-containing composite material can achieve light-weight and light-and-thin. The polyimide aerogel has good flexibility, thereby the polyimide aerogel-containing composite material has good processibility and applicability. From another point of view, the polyimide aerogel-containing composite material is obtained from the fabric and the polyimide aerogel composited with each other, thus the polyimide aerogel-containing composite material has better robustness related to the fabric or the polyimide aerogel. Therefore, the polyimide aerogel-containing composite material may be adopted for outdoor fabric membranes, protective suits, fire-fighting suits, space suits, flameproof clothes, etc.

The features of the invention are more specifically described in the following with reference to Examples 1-3. Although the following Examples are described, the material used, the material usage amount and ratio, processing details and processing procedures, etc., can be suitably modified without departing from the scope of the invention. Accordingly, restrictive interpretation should not be made to the invention based on the examples described below.

### Example 1

### Preparation of the Amino-Containing Silica Particle

At room temperature, 4.17 g of tetraethoxysilane (made by Acros Company) and 1.11 g of 3-aminopropyltriethoxysilane (made by Acros Company) were dissolved in 10 g of DMAc as a solvent. Next, 0.5 g of NaOH as a catalyst was added to the mixture within 30 minutes with stirring at room temperature. Then, a hydrolysis-condensation reaction was performed with constant stirring for 4 hours at 30° C. After that, the solvent was removed by centrifugation to obtain the amino-containing silica particle of Example 1, wherein the equivalent number of amino group of the amino-containing silica particle is 8.5 mmole/g.

### Preparation of the Composition for Forming the Polyimide Aerogel

2.1229 g (0.01 mol) of 3,3′-dimethylbenzidine (hereinafter referred to as DMB), 3.0893 g (0.0105 mol) of 3,3′,4,4′-biphenyltetracarboxylic dianhydride (hereinafter referred to as BPDA), 1.7374 g of the amino-containing silica particle of Example 1, and 65 g of NMP as a solvent were added into a 100 mL of three-necked flask with a mechanical stirring device. DMB, BPDA, and the amino-containing silica particle of Example 1 were stirred in the solvent for 8 hours in a nitrogen environment at room temperature to mix well, thereby obtaining the composition for forming the polyimide aerogel of Example 1 with the solid content of 10 wt %.

### Preparation of the Polyimide Aerogel

In a nitrogen environment at 30° C., the composition for forming the polyimide aerogel of Example 1 was stirred constantly, and 5 mL of pyridine and 10 mL of acetic anhydride as catalysts were added to perform a polycondensation and cyclization reaction for 8 hours to form the wet gel of Example 1. Then, 0.15 g of diisocyanate-based crosslinking agent (diphenyl methane diisocyanate) was added into the wet gel of Example 1. Also, 200 mL of a mixture solution of acetone and water was prepared, wherein the volume ratio of acetone to water was 7:3. Then, 0.5 g of fluorine-based surfactant (commercial product 3M™ Novec™ 4200 made by 3M Company) was added into the mixture solution of acetone and water. Next, at 30° C., the obtained wet gel of Example 1 was immersed in the obtained mixture solution of acetone and water for 4 hours to perform a solvent exchange treatment. After that, at room temperature and pressure (30° C., 1 atm), the wet gel which had been subjected to the solvent exchange treatment was stood and dried for 4 hours to remove the mixture solution of acetone of water, thereby obtaining the polyimide aerogel of Example 1. Then, the measurement of the thickness was performed on the polyimide aerogel of Example 1 to obtain the thickness thereof is about 0.5 mm.

### Example 2

### Preparation of the Amino-Containing Silica Particle

Follow the fabricating process the same as Example 1 to fabricate the amino-containing silica particle of Example 2.

### Preparation of the Composition for Forming the Polyimide Aerogel

2.0024 g (0.01 mol) of 4,4′-diaminodiphenyl ether (hereinafter referred to as ODA), 3.0893 g (0.0105 mol) of BPDA, 1.6972 g of the amino-containing silica particle of Example 2, and 61 g of NMP as a solvent were added into a 100 mL of three-necked flask with a mechanical stirring device. ODA, BPDA, and the amino-containing silica particle of Example 2 were stirred in the solvent for 8 hours in a nitrogen environment at room temperature to mix well, thereby obtaining the composition for forming the polyimide aerogel of Example 2 with the solid content of 10 wt %.

### Preparation of the Polyimide Aerogel

In a nitrogen environment at 30° C., the composition for forming the polyimide aerogel of Example 2 was stirred constantly, and 5 mL of pyridine and 10 mL of acetic anhydride as catalysts were added to perform a polycondensation and cyclization reaction for 8 hours to form the wet gel of Example 2. Then, 0.15 g of diisocyanate-based crosslinking agent (diphenyl methane diisocyanate) was added into the wet gel of Example 2. Also, 200 mL of a mixture solution of acetone and water was prepared, wherein the volume ratio of acetone to water was 7:3. Then, 0.5 g of fluorine-based surfactant (commercial product 3M™ Novec™ 4200 made by 3M Company) was added into the mixture solution of acetone and water. Next, at 30° C., the obtained wet gel of Example 2 was immersed in the obtained mixture solution of acetone and water for 4 hours to perform a solvent exchange treatment. After that, at room temperature and pressure (30° C., 1 atm), the wet gel which had been subjected to the solvent exchange treatment was stood and dried for 4 hours to remove the mixture solution of acetone of water, thereby obtaining the polyimide aerogel of Example 2. Then, the measurement of the thickness was performed on the polyimide aerogel of Example 2 to obtain the thickness thereof is about 0.5 mm.

### Example 3

### Preparation of the Amino-Containing Silica Particle

Follow the fabricating process the same as Example 1 to fabricate the amino-containing silica particle of Example 3.

### Preparation of the Composition for Forming the Polyimide Aerogel

2.1229 g (0.01 mol) of DMB, 3.0893 g (0.0105 mol) of BPDA, 1.7374 g of the amino-containing silica particle of Example 3, and 65 g of NMP as a solvent were added into a 100 mL of three-necked flask with a mechanical stirring device. DMB, BPDA, and the amino-containing silica particle of Example 3 were stirred in the solvent for 8 hours in a nitrogen environment at room temperature to mix well, thereby obtaining the composition for forming the polyimide aerogel of Example 3 with the solid content of 10 wt %.

### Preparation of the Polyimide Aerogel

In a nitrogen environment at 30° C., the composition for forming the polyimide aerogel of Example 3 was stirred constantly, and 5 mL of pyridine and 10 mL of acetic anhydride as catalysts were added to perform a polycondensation and cyclization reaction for 8 hours to form the wet gel of Example 3. Then, 0.15 g of diisocyanate-based crosslinking agent (diphenyl methane diisocyanate) was added into the wet gel of Example 3. Also, 200 mL of a mixture solution of acetone and water was prepared, wherein the volume ratio of acetone to water was 7:3. Then, 0.05 g of fluorine-based surfactant (commercial product 3M™ Novec™ 4200 made by 3M Company) was added into the mixture solution of acetone and water. Next, at 30° C., the obtained wet gel of Example 3 was immersed in the obtained mixture solution of acetone and water for 4 hours to perform a solvent exchange treatment. After that, the wet gel which had been subjected to the solvent exchange treatment was frozen at −20° C., and then dried under vacuum (0.1 atm) for 8 hours to remove the mixture solution of acetone of water, thereby obtaining the polyimide aerogel of Example 3. Then, the measurement of the thickness was performed on the polyimide aerogel of Example 3 to obtain the thickness thereof is about 0.5 mm.

After that, measurements of porosity, heat transfer coefficient, maximum bending angle and dielectric constant were performed on the polyimide aerogel of each of Examples 1-3. The above-mentioned measurements are illustrated below, and the results of the measurements are shown in Table 1.

### <Measurement of Porosity>

First, the polyimide aerogel of each of Examples 1-3 was made into a film material with length and width dimensions of 3 cm×1 cm, and the density thereof was measured. Next, the measurement of the apparent density was performed by an apparent density measurement instrument (Micromeritics AccuPyc 1330). Namely, the polyimide aerogel was filled with helium or argon to measure the apparent density thereof. After that, the porosity of the polyimide aerogel can be obtained by conversion of a ratio of density to apparent density. A lower value of the porosity means a better void fraction and a better relative heat-insulation property of the polyimide aerogel.

### <Measurement of Heat Transfer Coefficient>

A heat transfer coefficient analyzer is to measure a capacity of a sample to transfer the heat in a condition that a fixed power is provided to a material sample. When the temperature of the object is inconsistent with the outside temperature, it produces heat transfer. The method of transferring heat mainly includes conduction, convection, and radiation. First, the polyimide aerogel of each of Examples 1-3 was made into a film material with length and width dimensions of 10 cm×10 cm. Then, heat flux of each of the film materials was measured by a heat transfer analysis device (Hot Disk TPS 2500). The method was a transient plane heat source method test operating standard. A lower value of heat transfer coefficient means a better thermal insulation of the polyimide aerogel.

### <Measurement of Maximum Bending Angle>

First, the polyimide aerogel of each of Examples 1-3 was made into a film material with length and width dimensions of 5 cm×5 cm. Then, 1 kg of external force was applied to each of the film materials for bending, and the maximum bending angle was measured when the film material was not broken. In the standard setting in industry, when the maximum bending angle is 360 degrees means the film material is capable of folding backward.

### <Measurement of Dielectric Constant>

First, the polyimide aerogel of each of Examples 1-3 was made into a film material with length and width dimensions of 10 cm×10 cm. Then, dielectric constant of each of the film materials was measured by a dielectric constant measuring device (Agilent-8722ES) at measuring frequency of 0˜1 GHz. In the standard setting in industry, dielectric constant of the polyimide aerogel is preferably equal to or less than 1.5, and a lower value means a better dielectric property.

TABLE 1

| | Example 1 | Example 2 | Example 3 |
|---|---|---|---|
| Porosity (%) | 87 | 87 | 88 |
| Heat transfer coefficient | 43 | 43 | 42 |
| (mW/m · k) | | | |
| Maximum bending | 360 | 360 | 320 |
| angle (degree) | | | |
| Dielectric constant | 1.2 | 1.3 | 1.1 |

From Table 1, it can be known that the polyimide aerogels of Examples 1-3 had good performances in porosity, heat transfer coefficient, maximum bending angle, and dielectric constant. It means that by using the composition including the diamine monomer and the tetracarboxylic dianhydride monomer in a specific ratio range, and a specific content range of the amino-containing silica particle fabricated by using the alkoxy silane represented by formula (I) and the alkoxy silane represented by formula (II) to fabricate the polyimide aerogel, the polyimide aerogel had high porosity, good thermal insulation, good flexibility, and low dielectric constant.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An amino-containing silica particle is obtained by hydrolysis-condensation reaction of an alkoxy silane represented by formula (I), an alkoxy silane represented by formula (II) and a catalyst:
Si(OR¹)₄ formula (I)
(NH₂—Y)ₘ—Si(OR²)₄₋ₘ formula (II)
wherein in formula (I), R1 is a C1-C10 alkyl group; and
in formula (II), Y is a C₁-C₁₀ alkyl group or a C₂-C₁₀ alkenyl group, R² is a C₁-C₁₀ alkyl group, and m is an integer of 1 to 3.

2. The amino-containing silica particle according to claim 1, wherein an equivalent number of amino group of the amino-containing silica particle is 5 mmole/g to 10 mmole/g.

3. The amino-containing silica particle according to claim 1, wherein the alkoxy silane represented by formula (I) comprises tetraethoxysilane, and the alkoxy silane represented by formula (II) comprises 3-aminopropyltriethoxysilane.

4. A composition for forming a polyimide aerogel, comprising:
a diamine monomer;
a tetracarboxylic dianhydride monomer, and a molar ratio of the diamine monomer to the tetracarboxylic dianhydride monomer is 1:1 to 1:1.5;
the amino-containing silica particle according to claim 1, and a weight percent of the amino-containing silica particle is 10 wt % to 40 wt %, based on a total weight of the composition for forming the polyimide aerogel; and
a solvent.

5. The composition for forming the polyimide aerogel according to claim 4, wherein a solid content of the composition for forming the polyimide aerogel is 5 wt % to 20 wt %.

6. The composition for forming the polyimide aerogel according to claim 4, wherein the diamine monomer is 4,4′-oxydianiline (ODA), 3,3′-dimethylbenzidine (DMB), p-phenylenediamine (p-PDA), m-phenylenediamine (m-PDA), 2,2′-bis[4-(4-aminophenoxyphenyl)] propane (BAPP), or 2,2-bis(trifluoromethyl) benzidine (TFMB), and the tetracarboxylic dianhydride monomer is 3,3′,4,4′-biphenyltetracarboxylic dianhydride (BPDA), pyromellitic dianhydride (PMDA), 3,3′,4,4′-benzophenone tetracarboxylic dianhydride (BTDA), 4,4′-oxydiphthalic anhydride (ODPA), or 4,4′-(hexafluoroisopropylidene)diphthalic anhydride (6FDA).

7. The composition for forming the polyimide aerogel according to claim 4, wherein the solvent is selected from at least one of N-methylpyrrolidone, dimethylacetamide, dimethylformamide, tetrahydrofuran, and phenol.

8. A method of fabricating a polyimide aerogel, comprising:
mixing a diamine monomer, a tetracarboxylic dianhydride monomer, and an amino-containing silica particle in a solvent uniformly to obtain the composition for forming the polyimide aerogel according to claim 4;
performing a polycondensation and cyclization reaction of the composition for forming the polyimide aerogel to form a wet gel;
performing a solvent exchange treatment on the wet gel with a mixture solution of acetone and water; and
performing a drying treatment on the wet gel which has been subjected to the solvent exchange treatment.

9. The method of fabricating the polyimide aerogel according to claim 8, wherein a volume ratio of acetone to water in the mixture solution of acetone and water is 10:90 to 90:10.

10. The method of fabricating the polyimide aerogel according to claim 8, further comprising adding a crosslinking agent into the wet gel before performing the solvent exchange treatment.

11. The method of fabricating the polyimide aerogel according to claim 10, wherein an additive amount of the crosslinking agent is 1 wt % to 10 wt %, based on a total weight of the wet gel.

12. The method of fabricating the polyimide aerogel according to claim 10, wherein the crosslinking agent is a diisocyanate-based crosslinking agent, a diamine crosslinking agent, a triamine crosslinking agent, or a glycol-based crosslinking agent.

13. The method of fabricating the polyimide aerogel according to claim 8, further comprising adding a surfactant into the mixture solution of acetone and water.

14. The method of fabricating the polyimide aerogel according to claim 13, wherein an additive amount of the surfactant is 0.01 wt % to 1 wt %, based on a total weight of the mixture solution of acetone and water.

15. The method of fabricating the polyimide aerogel according to claim 13, wherein the surfactant is a fluorine-based surfactant.

16. A polyimide aerogel is fabricated by the method of fabricating the polyimide aerogel according to claim 8.

17. The polyimide aerogel according to claim 16, wherein a porosity of the polyimide aerogel is 85% to 95%.

18. The polyimide aerogel according to claim 16, wherein a thickness of the polyimide aerogel is 0.1 mm to 1 mm.

19. A polyimide aerogel-containing composite material, comprising:
a fabric; and
the polyimide aerogel according to claim 16, wherein the fabric and the polyimide aerogel are composited with each other.
